(19) United States
(12) Patent Application Publication
(10) Pub. No.: US 2004/0194017 A1
(43) Pub. Date: Sep. 30, 2004

(54) Interactive video interface

(76) Inventor: Jasmin Cosic, Woonsocket, RI (US)

Correspondence Address: FISH & RICHARDSON PC, 225 FRANKLIN ST, BOSTON, MA, 02110, US

(21) Appl. No.: 10/751,677

(22) Filed: Jan. 5, 2004

Related U.S. Application Data
(60) Provisional application No. 60/438,264, filed on Jan. 6, 2003.

(51) Int. Cl. G06F 17/21

(52) U.S. Cl. 715/501.1

(57) ABSTRACT

A method, for use in an interactive video interface, includes defining a structure of nodes, wherein a node comprises a data structure containing a link to content, selecting the link, and generating an output that is based on the content. The link is one of plural links to different content accessible via the node, and selecting the link includes selecting among the plural links.

### CROSS-REFERENCE TO RELATED APPLICATIONS

This application claims priority to U.S. Provisional Application No. 60/438,264, filed on Jan. 6, 2003, the contents of which are hereby incorporated by reference into this application as if set forth herein in full.

### TECHNICAL FIELD

This application relates to mapping abstract image nodes onto, or within, a physical or non-physical site, terrain, or object, a process that allows users to move from one image node to another, and an interface that connects image nodes with external applications and processes.

### BACKGROUND

Video is a composition of sequentially changing images. This composition is characterized by a set of images changing in a predefined order. Although, video can incorporate images taken by multiple cameras or generated by a computer, video is merely a view of what the director of the video wanted viewers to see. Images used in video can be of extraordinary beauty and exciting content. However, the nature of video derived from its predefined sequence of changing images makes video inflexible from the viewers' standpoint. The only operations viewers can perform on video are forward and rewind. The notion of seeing predetermined images, scenes, and views in a video is one reason why viewers usually watch a video once, but do not usually re-watch the same video often.

In contrast to the foregoing are computer-generated objects where users can move the view of the object. A successful implementation of this approach to presenting visual content is a modern 3D computer game such as Duke Nukem by 3D Realms Entertainment. This approach does not rely on the sequence of images to show visual content. Instead, it electronically defines an object (e.g., house, stadium, car, etc.), which a user can view from different angles and distances including entering the interior of the object. This feature places the user in the center of the scene providing interactivity that video lacks. This is one reason why computer game players can spend hours and days viewing the scenes of the same computer game.

Because of its complexity of creation and use, the approach of electronically defining and viewing objects found its use limited to computer games, engineering (CAD/CAM), and high tech business projects. There is a need for a method of presenting visual content that resembles the simplicity of video and interactivity of a computer game.

### SUMMARY

The subject invention meets the foregoing need by mapping image nodes onto, or within, a physical or non-physical site, terrain or object, by enabling users to move from one image to another, and by connecting image nodes with external applications and processes.

In general, in one aspect, the invention is directed to a method that includes defining a structure of nodes, where a node comprises a data structure containing a link to content, selecting the link, and generating an output that is based on the content. This aspect may include one or more of the following features.

The content may include an object, and generating the output may include executing code associated with the object. The content may include visual or non-visual content, such as digital images, video, and/or an interactive process. The interactive process may be implemented via a graphical user interface. The content may include another node of the structure of nodes. The link may include one of plural links to different content accessible via the node, and selecting the link may include selecting among the plural links. The structure of nodes may include one or more of the nodes positioned at locations that correspond to content.

The method may include generating a user interface to interact with the structure of nodes and to present the output. The content may include one of external content and internal content. The internal content may be located inside the node and the external content may be located outside the node.

Other features and advantages of the invention will become apparent from the following description, including the claims and drawings.

### BRIEF DESCRIPTION OF THE DRAWINGS

FIG. 1 is a diagram showing IVI's abstract structure.

FIG. 2 shows nodes showing a random figure.

FIG. 3 shows nodes showing a line-delimited figure.

FIG. 4 is a diagram showing an image node and its fields.

FIG. 5 is a flow diagram showing IVI's internally initiated interaction with external applications and processes.

FIG. 6 is a flow diagram showing IVI's externally initiated interaction with external applications and processes.

FIG. 7 is a diagram showing IVI's physical structure.

FIG. 8 shows a Web browser showing GUI components for IVI as a walk-through simulator of a college campus.

FIG. 9 is a diagram showing IVI display GUI component interpreting and showing visual or non-visual content.

Like reference numerals in different figures indicate like elements.

### DESCRIPTION

Interactive Video Simulator (IVI) 100 is a computer program to map abstract image nodes 200 onto, or within, a physical or non-physical site, terrain, or object, a process that allows users to move from one image node 200 to another, and an interface 120 that connects image nodes 200 with external applications and processes 130.

A first embodiment of IVI, which represents a visual content interface, is implemented as a walk-through simulator. In the example described herein, the walk-through simulator is mapped onto a college campus. IVI 100, in one implementation, is two-dimensional (i.e., it is mapped onto a two-dimensional terrain). However, IVI is designed to, and allows mapping of, multi (e.g., three or more)-dimensional image nodes onto, or within, multi (e.g., three or more)-dimensional sites, terrains or objects. In general, IVI allows users to move from one image node to a next image node in a multidimensional space in all conceivable directions including, but not limited to, up, down, left, right, reverse, diagonal, parabolic, hyperbolic, circular, and elliptical directions.

The underlying data structure utilized to organize image nodes 200 within IVI 100 closely resembles a doubly linked graph (i.e., a data structure comprised of doubly linked data nodes). Since a matrix can be construed as a form of an organized table-like graph, IVI 100 uses matrix 300 as the underlying data structure to organize image nodes 200.

IVI 100, however, is not limited to using a matrix. IVI is independent of the underlying data structure utilized to organize image nodes 200, and may utilize any data structure. Such data structures may include, but are not limited to, graphs, linked lists, doubly linked lists, trees, heaps and multidimensional matrices. In general, IVI contains image nodes with multiple links to other image nodes. Therefore, practically and logically, each IVI possesses its own unique data structure.

Conceptually, IVI is divided into abstract and logical structures. Described herein are two separate embodiments of IVI: (1) a visual content IVI (the first embodiment) and (2) non-visual content interface (the second embodiment). Except for the differences in the graphical presentation of content, the underlying processes for both embodiments are the same.

### FIRST EMBODIMENT

### Visual Content IVI

Abstract Structure

IVI's abstract structure portrays how IVI functions internally. Abstractly (i.e., from the perspective of internal processes), IVI operates through main engine program 110 (hereinafter referred to as the “engine program”) and external applications and processes connectivity interface 120 (EAPCI). Engine program 110 organizes and controls matrix 300 (or any other data structure utilized to organize or describe IVI), and movement from one image node 200 to another. EAPCI 120 relates IVI image nodes 200 to external applications and processes 130 (e.g., 360° views or interactive maps).

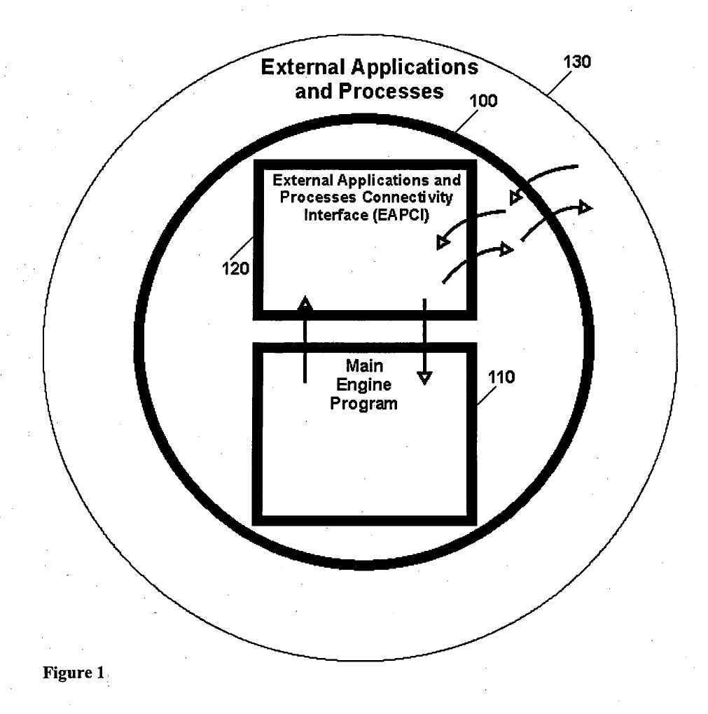

FIG. 1 is a diagram showing IVI's 100 abstract structure, including engine program 110, external applications and processes interface 120, and external applications and processes 130.

Engine Program

Matrix

A part of the engine program 110 is the data structure utilized to organize IVI. In this case, this includes matrix 300 of image nodes 200 mapped onto or within a site, terrain or object that IVI represents. Matrix 300 contains image nodes 200 interconnected by links 220, 230, 240 and 250 (additional links may be defined). Depending on the configuration of the site, terrain, or object onto or within which IVI is mapped, image nodes 200 within matrix 300 may be organized to show a random figure or a line-delimited figure in one implementation of IVI.

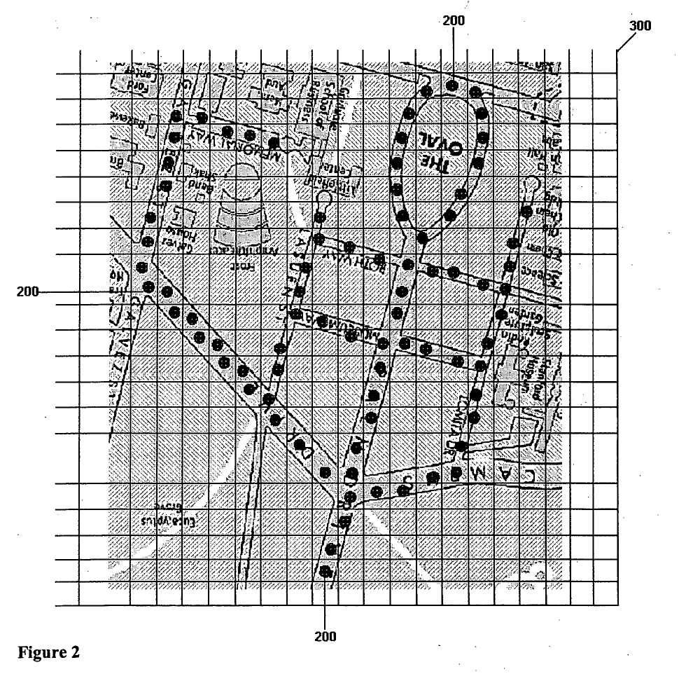

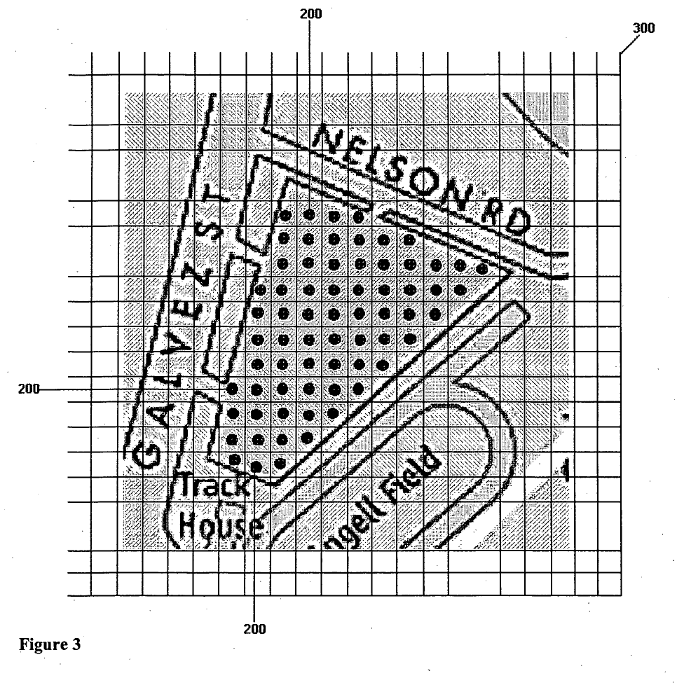

FIG. 2 shows matrix 300 including image nodes 200 mapped onto pathways of a college campus showing a random figure. FIG. 3 shows matrix 300 including image nodes 200 mapped within a building of a college campus showing a line-delimited figure.

Image Node

An image node 200 may be a data structure that comprises (1) fields containing links 210 to image objects and (2) fields containing links (e.g., 220, 230, 240, 250 ) to other image nodes 200 or to external applications and processes 130. Image object link 210 can point, e.g., to a photograph, a computer-generated image, or an external application or process of any type. In the case that the image object link 210 points to an external application or process 130, such application or process may generate an image, video, a 360° view, or any other type of visual data. In general, image object link 210 can point to images or visual content, and also to applications or processes outputting visual or non-visual content, including active applications or processes. An active application or process is an interactive application or process that is running while it is presented through IVI.

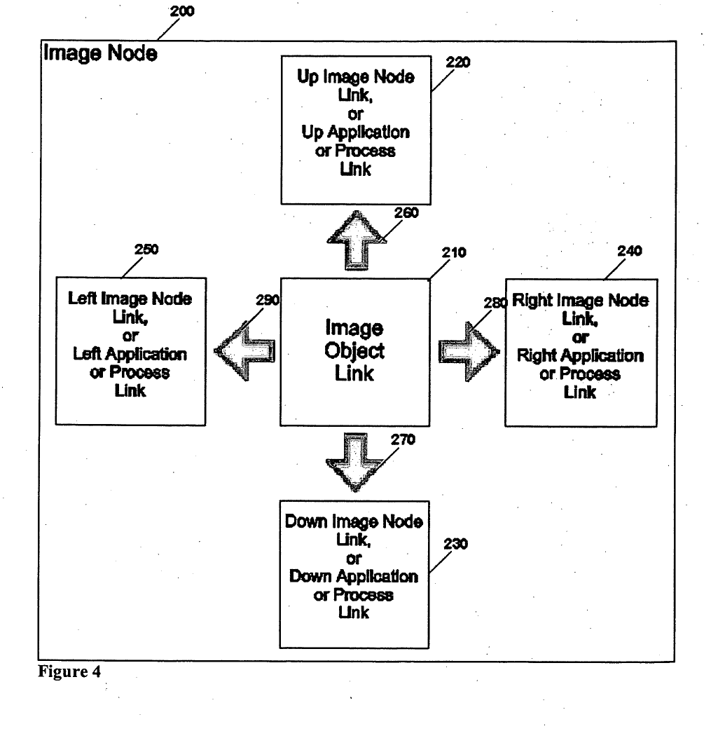

Image node 200 can contain (1) any number of fields containing links to image objects (e.g. 210) and (2) any number of fields containing links (e.g. 220, 230, 240 and 250) to other image nodes 200 or to external applications and processes 130. In one implementation of IVI 100, image node 200 contains five fields: image object link 210, up link 220, down link 230, right link 240, and left link 250. In the case of a three-dimensional IVI, additional image node or external applications or processes links would include, but are not limited to, above link, below link, diagonal link, behind link, around link (e.g. parabolic, hyperbolic or elliptical), and others. Image node or external applications or processes link (e.g. 220, 230, 240 and 250) fields may be empty, point to other image nodes 200, or point to external applications or processes 130. Therefore, types of links within image nodes 200 include (1) empty, (2) image node, or (3) external application or process type. FIG. 4 shows image node 200 and its fields.

Engine Program's Functioning

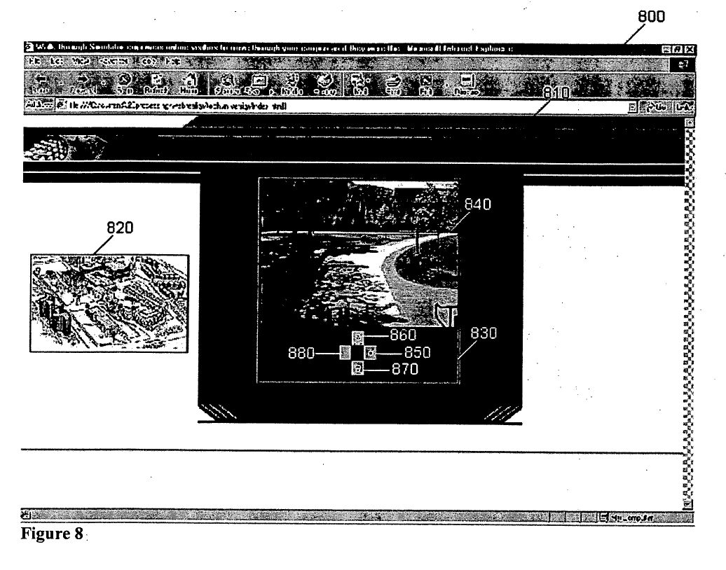

IVI 100 starts by engine program 110 loading a predefined starting image node, and executing the image object link. Any image node 200 within the matrix 300 can be defined to be the starting node, and any image object link 210 within an image node 200 can be defined as the starting image object link. Once the initial image node is loaded, engine program 110 executes the object to which the link specified in the starting image object link field points. Once the object is executed, engine program 110 shows the executed image object's output through the IVI display GUI component 840 (FIG. 8). In the case that the image object link 210 points to a simple data type such as an image or video, the executed image object's output is the corresponding image or video. In the case that the image object link 210 points to an external application or process 130, the executed image object's output is any type of visual content generated by the execution of the corresponding external application or process. In any case, where image object link 210 points to an external application or process 130, the external application or process is executed, and its output is provided through the IVI display GUI component 840.

The output of the executing image object may comprise an active application or process in which case users can interact with the active application or process through the IVI display GUI component 840. For example, an external application or process 130 may be an active application that allows users to click on multiple images of a site, terrain or object. Users would be able to interact with the external application through the IVI display GUI component 840 without moving from one image node 200 to another. One application of this IVI feature is its ability to show multiple views of the same location on or within a site, terrain, or object including reversing the view of the scene. For example, in the case that IVI presents a college campus and its pathways, a user would not be limited to only “walking” through the pathways (one purpose of the IVI), but users may view the present location of each step (image node) in all directions including turning back (reversing the view of the scene). Another example of executing active applications within IVI display GUI component 840 is presenting “360° views” that allow users to rotate by 360° the view of the scene.

In addition to execution of the image object link 210, engine program 110 associates the currently loaded image node or external application or processes links (e.g. 220, 230, 240 and 250) with the direction arrow GUI components (e.g. 850, 860, 870, 880) presented to the user in the IVI window GUI Component 830. After a user clicks on one of IVI's direction arrows (e.g. 850, 860, 870, 880), engine program 110 loads an image node 200 to which the link associated with the clicked direction arrow points. Loading a new image node 200 triggers the same process described above of executing image object link 210, showing its output through IVI display GUI component 840, and associating the newly loaded image node's image node or external application or processes links (e.g. 220, 230, 240 and 250; additional links may be defined) with the direction arrows GUI components (e.g. 850, 860, 870, 880) within the IVI window GUI component 830.

External Applications and Processes Connectivity Interface (EAPCI)

EAPCI is a collection of global functions executable by engine program 110 and by external applications and processes 130. IVI 100 interacts with external applications and processes 130 in two ways: internally initiated, and externally initiated interaction. In the case that an image node 200 needs to execute an external application or process 130, it first executes a global function 610 within EAPCI 120 including passing execution parameters to the global function 610. The executing EAPCI global function then references and executes the desired external application or process 130. Conversely, in the case that an external application or process 130 needs to execute an IVI's internal function 600, it first executes an EAPCI global function 610 associated with the desired internal function 600, including passing execution parameters to the global function 610. The executing EAPCI global function 610 then references and executes the desired internal function 600.

Examples of EAPCI Functioning

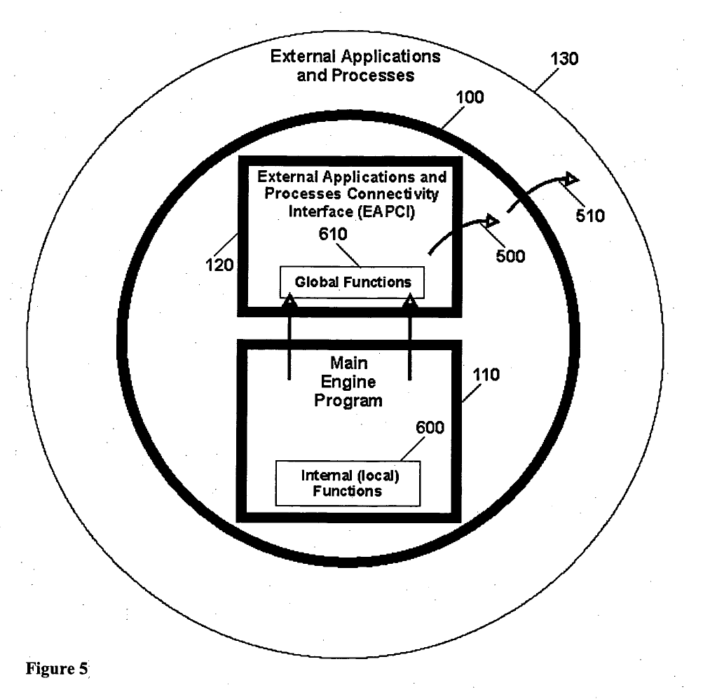

Internally initiated interaction with external applications and processes 130 occurs when image node 200 or IVI's internal function 600 references and executes external application or process 130. When a link (e.g., 210 or 240) that points to an external application or process 130 is executed, engine program 110 executes the application or process to which the link points (e.g. opening a Web browser window containing a “360° view”). The way engine program 110 executes external applications and processes 130 is by recognizing the type of the link to be external application or process type, and by passing execution parameters to EAPCI 120. EAPCI 120 then executes one of its global functions 610 by passing to it the execution parameters received from engine program 110. This executing global function 610 executes the desired external application or process 130 including passing the execution parameters to it. In general, engine program 110 can execute external application or process 130 for which there exists a global function 610 within EAPCI 120. FIG. 5 shows IVI's internally initiated interaction with external applications and processes 130.

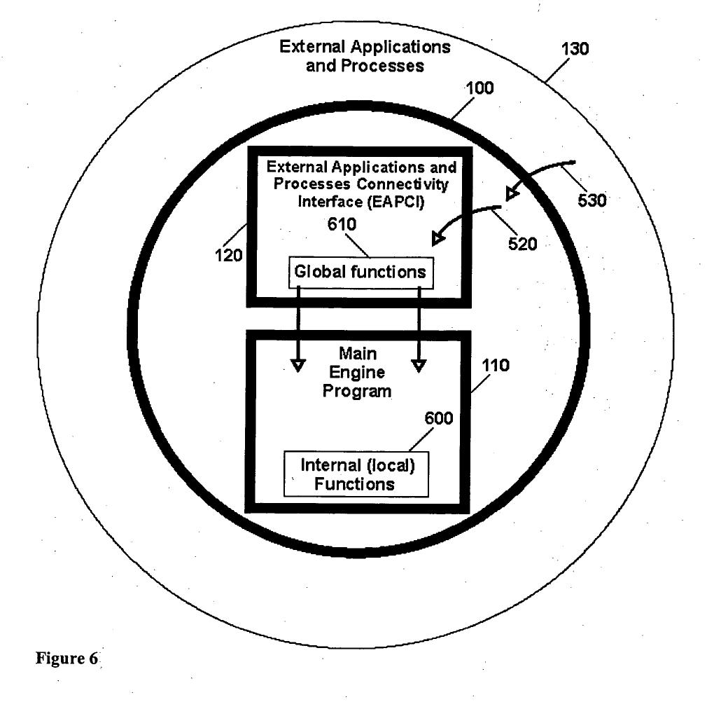

Externally initiated interaction with external applications and processes 130 occurs when an external application or process 130 references and executes an IVI's internal function 600. This execution is possible because EAPCI 120 contains global functions 610 associated with some of internal functions 600. Global functions 610, as opposed to internal functions 600, can be executed by external applications and processes 130. Once EAPCI 120 receives an execution call from an external application or process 130 to one of its global functions 610, EAPCI 120 executes the global function 610 including passing to it execution parameters provided by the external application or process 130. The executing global function 610 then executes the desired internal function 600 associated with the executing global function 610. This way, an external application or process 130 can load image nodes 200 and execute their image object links 210 within IVI. In general, external applications and processes 130 can execute engine program's 110 internal function 600 for which there exists a global function 610 within EAPCI 120. FIG. 6 shows IVI's externally initiated interaction with external applications and processes.

Physical File Structure and Engine Program's Interaction with It

IVI's 100 physical structure defines files where program code and image nodes data are stored, and it defines how engine program 110 interacts with these files. Before IVI 100 can function, it initiates engine program 110 by executing the executable code that makes up engine program 110 and that is stored in a file (or any other storage medium, apparatus or software). IVI, in one implementation, uses Java applet 830 embedded into a Web page 810 to initiate the engine program 110. Once Web page 810 containing IVI Java applet 830 is loaded and executed by a Web browser 800 (e.g. Microsoft Internet Explorer® or Netscape Navigator®), Java applet 830 initiates engine program 110 by reading and executing the engine program's Executable Code File 410. Java applet 830 is a Java program modified in such a way to be suitable for embedding and execution within other applications and programming languages including, but not limited to, markup (e.g. HTML, XML, DHTML, etc.).

IVI is not limited to use a Java applet for the execution of engine program 110. IVI may be implemented using any programming language. For example, programming languages that can be used to implement IVI include, but are not limited to, HTML, XML, DHTML, Java, C++, Visual Basic, Basic, Perl, and PhP. Languages and applications that IVI can be embedded into include, but are not limited to, HTML, XML, DHTML, VRML, Microsoft Power Point, Lotus applications, Corel applications, Adobe applications, and Netscape Messenger.

FIG. 8 shows Internet Explorer® Web browser 800 containing a Web page 810 that contains GUI components (including IVI window GUI component 830 and its internal GUI components) used in one implementation of the IVI. IVI window GUI component is a graphical representation of the IVI Java applet; therefore, the phrases “IVI window GUI Component” and “IVI Java applet” are labeled with the same reference numeral 830 and are used synonymously.

The following is the statement embedded into Hypertext Markup Language (HTML) of Web page 810 that contains Java applet 830 that initiates engine program 110 in one implementation of IVI:

<APPLET
ARCHIVE=“interactiveVideoInterface.jar”
CODE=“interactiveVideoInterface.class”
NAME=“interactiveVideoInterface”
HEIGHT=305 WIDTH=300
>

In the above statement, ARCHIVE=“interactiveVideoInterface.jar” is the name of the file where the engine program's 110 executable code is stored; CODE=“interactiveVideoInterface.class” is the object of the engine program's 110 executable code; NAME=“interactiveVideoSimulator” is the name of the Java applet 830 within the Web page 810; and HEIGHT=305 WIDTH=300 are height and width of the IVI Java applet 830 in pixels within Web page 810.

Following initiation of Java applet 830, engine program 110 creates image nodes 200 by reading and interpreting image nodes data file 420. This file contains information on image nodes 200 and their fields, as well as information on which image node is the starting node. In one implementation of IVI, data needed to create image nodes 200 within engine program 110 is embedded into the HTML of Web page 810 containing the IVI Java applet 830. However, engine program's 110 executable code can be stored in a file separate from both Web page's 810 HTML and engine program's Executable Code File 410.

In general, data that describes image nodes 200 within engine program 110 is stored in a file associated with any device, software or apparatus where digital data can be stored. The following is the structure of the image nodes data file 420 used in one implementation of IVI:

| | |
|---|---|
| <PARAM NAME=image0 | VALUE=“10.jpg”> |
| <PARAM NAME=right0 | VALUE=“null777123”> |
| <PARAM NAME=left0 | VALUE=“null777123”> |
| <PARAM NAME=up0 | VALUE=“11.jpg”> |
| <PARAM NAME=down0 | VALUE=“null777123”> |
| <PARAM NAME=image1 | VALUE=“11.jpg”> |
| <PARAM NAME=right1 | VALUE=“null777123”> |
| <PARAM NAME=left1 | VALUE=“20000.jpg”> |
| <PARAM NAME=up1 | VALUE=“12.jpg”> |
| <PARAM NAME=down1 | VALUE=“10.jpg”> |
| ... | |

The first set of image node field definitions (first five lines of the above code containing “PARAM NAME” definitions) represents the starting image node whose content is shown through IVI display GUI component 840 when the engine program 110 initiates.

<PARAM NAME=image0 VALUE=“10.jpg”> indicates that the starting image node's image object link 210 is an image with name “10.jpg”.

<PARAM NAME=right0 VALUE=“null777123”> indicates that the starting image node's Right image node or external applications or processes Link 240 is empty and does not point to an image node 200, or to an external application or process 130. Statement VALUE=“null777123” represents an empty link in one implementation of IVI.

<PARAM NAME=left0 VALUE=“null777123”> indicates that the starting image node's Left image node or external applications or processes Link 250 is empty and does not point to an image node 200, or to an external application or process 130.

<PARAM NAME=up0 VALUE=“11.jpg”> indicates that the starting image node's Up image node or external applications or processes Link 220 is an image node containing image object link 210 pointing to an image named “11.jpg”.

<PARAM NAME=down0 VALUE=“null777123”> indicates that the starting image node's Down image node or external applications or processes Link 230 is empty and does not point to an image node 200 or to an external application or process 130.

The remaining statements, namely

| | |
|---|---|
| “<PARAM NAME=image1 | VALUE=“11.jpg”> |
| <PARAM NAME=right1 | VALUE=“null777123”> |
| <PARAM NAME=left1 | VALUE=“20000.jpg”> |
| <PARAM NAME=up1 | VALUE=“12.jpg”> |
| <PARAM NAME=down1 | VALUE=“10.jpg”>” |

follow the same philosophy of defining additional image nodes 200 and their fields based on the above-described starting image node definition procedure. The ellipses “ . . . ” indicate that more than two image nodes 200 may be defined within the engine program 110.

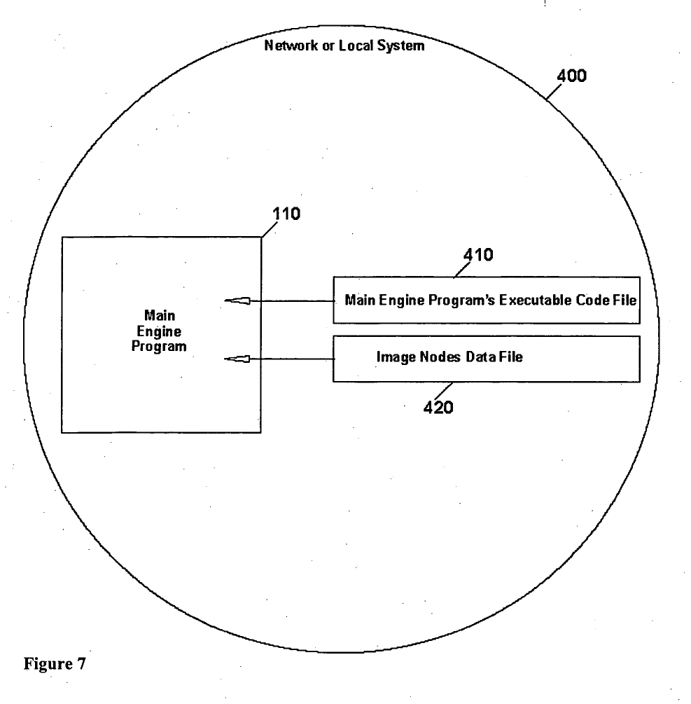

FIG. 7 shows IVI's physical structure including the engine program's Executable Code File 410 and image nodes data file 420.

Logical Structure

IVI's 100 logical structure portrays how IVI functions from the user's perspective. IVI's logical structure includes the Graphical User Interface (GUI) and the GUI's interaction with engine program 110.

Graphical User Interface (GUI)

The GUI has two functions within IVI 100. It (1) presents users with visual content (images, video, 360 views, etc.) based on their current image node 200 within IVI and (2) provides users with a means to input operating instructions to IVI. The primary means to input operating instructions into IVI is activating direction arrows GUI components (e.g. 850, 860, 870, 880) explained in detail below. Operating instructions include, but are not limited to, moving from one image node 200 to another, and initiating interaction with external applications and processes 130. The following GUI components may be used within IVI: IVI window 830, IVI display 840, direction arrow (e.g. 850, 860, 870, 880; additional direction arrows may be defined), map 820, and “360° view”.

FIG. 8 shows Internet Explorer Web Browser 800 containing a Web page 810 that further contains GUI components (including IVI window GUI Component 830 and its internal GUI components) used in one implementation of IVI.

IVI Window

IVI window 830 is a visual representation of IVI. IVI window 830 contains IVI display 840 and direction arrows (e.g. 850, 860, 870, 880), and may contain other Components. IVI display 840 and direction arrows are IVI's internal GUI components in one implementation of IVI. In general, users move through a site, terrain or object onto, or within, which IVI is mapped (1) by pressing computer keyboard buttons associated with IVI direction arrows (e.g. 850, 860, 870, 880), (2) by clicking on the direction arrows within IVI window 830, (3) by clicking on certain locations on visual content presented through IVI display 840, and/or (4) by interacting with external applications and processes 130.

One implementation of IVI allows users to “walk” through a college campus' walkways by activating direction arrows 850, 860, 870 and 880, which execute image nodes 200 and show images of a natural step-by-step (node-by-node) walk-through the campus. The following are examples of how IVI window interacts with external applications and processes 130, namely map 820 (for externally initiated interaction) and 360° view (for internally initiated interaction) in order to deliver a seamless interactive motion through the college campus.

In one implementation of IVI, map 820 is an external application or process 130. Upon a user's clicking on a map's 820 “hot spot” (predefined location of interest on a college campus), map 820 references and executes an IVI global function 610 associated with IVI's internal function 600 that executes image nodes 200 including passing the execution parameter that defines which image node 200 is to be executed. Clicking on a map's hot spot allows a user to quickly access and display visual content (images in one implementation of IVI) of image node 200 associated with the clicked location of interest without moving from one image node 200 to another in order to arrive at the said location of interest.

In one implementation of IVI, 3600 view is an external application or process 130, although, in different implementations of IVI, 360° view may be shown through IVI display 840 in which case it is not an external application or process. In one implementation of IVI, some walkways lead to campus buildings such as the library, cafeteria, or laboratories. Once users approach the buildings' entrances by moving from one image node 200 to another, they may “enter” the buildings by activating up image node, or external application or process link 220 of the current image node 200, which executes (opens) a Web page containing a 3600 view of the entered building.

In the case of a user entering a building, engine program's 110 internal function 600 that executes image nodes' 200 image node, or external application or process Links 220, 230, 240 and 250, recognizes that the link contains a reference to an external application or process 130. Internal function 600 then executes an external function 610 responsible for executing external 360° views including passing the execution parameter that defines which 360° view is to be executed.

IVI Display

IVI display 840 shows visual content pointed to by the image object link 210 of the current image node 200. Image object link 210 primarily points to images, videos or other visual content, or to active applications or processes in which case users can interact with the active application or process through the IVI display 840.

One implementation of IVI contains IVI display 840 that shows images of a college campus. Showing Images is only one of IVI display's 840 functions. In general, IVI display 840 shows a graphical representation of any visual or non-visual content as long as the IVI display 840 possesses access to a plug-in 910 that contains information on how to graphically interpret and show a particular visual or non-visual content. In the case that IVI display 840 does not possess access to a plug-in 910 that contains information on how to graphically interpret and show a particular visual or non-visual content, IVI display 840 uses a simple text editor (e.g., Notepad) available on the computing or communication device on which IVI is executing to show text representation of the visual or non visual content. In one implementation of IVI, IVI display 840 uses plug-ins 910 installed in Web browser 800 that executes Web page 810 in which IVI window 830 is embedded.

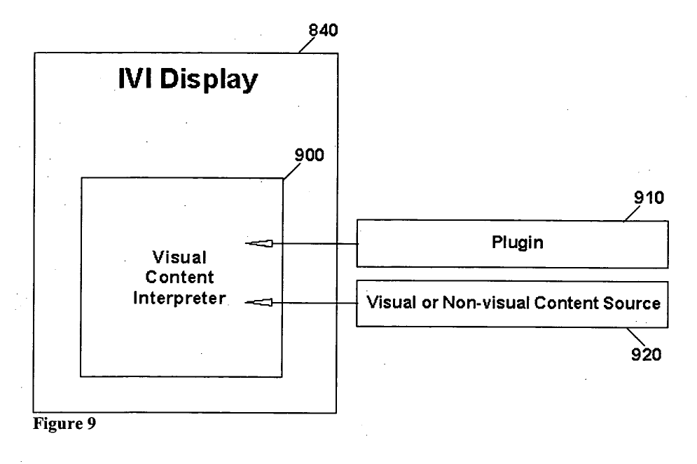

FIG. 9 shows IVI display 840, visual content interpreter 900, plug-in 910 and visual or non-visual content source 920, and how these components interact to interpret and show visual content.

Visual content interpreter 900 within IVI display 840 recognizes which type of content the visual or non-visual content source 920 is requesting IVI display 840 to show. Visual content interpreter 900 then interprets the content coming from the visual or von-visual content source 920 using the plug-in 910. The interpretation is a process of conversion of visual or non-visual content into visual content (graphical representation). Upon the visual content interpreter's 900 interpreting content from visual or non-visual content source 920, IVI display 840 shows visual content. Plug-in 910, which contains information on how to interpret visual or non-visual content may reside anywhere (e.g. random access memory, read only memory, hard drive, floppy drive, etc.) on a computing or communication device on which IVI is executing, or on a network to which the computing or communication device executing IVI is connected.

Direction Arrow

Direction arrows (e.g. 850, 860, 870, 880) within IVI serve as one, but not the only, means of submitting operating instructions to the engine program 110. Direction arrows are implemented as push buttons in one implementation of IVI. Direction arrows can also be implemented as images or other visual representation of direction signs. Users activate direction arrows by clicking on them using a mouse or by pressing the keyboard keys associated with particular direction arrows. Direction arrows within engine program 110 are associated with links to image nodes 200, or links to external application or processes 130. A direction arrow may also be associated with an empty link in which case it points to no image node 200, and no external application or process 130. When a user activates a direction arrow, engine program 110 executes a link associated with the activated direction arrow. Upon the execution of the link, engine program 110 follows the procedure described in the engine program's definition.

Image

Images are collections of colored dots (e.g., pixels) arranged in such a manner so they show visual content. Images within IVI serve as (1) visual content output (regular images) as well as (2) input for user's operating instructions (e.g. direction arrows implemented as images). Examples of images within one implementation of IVI include, but are not limited to, (1) the underlying visual content of a map 820 described in detail below and (2) visual content of the IVI display 840 shown in FIG. 8.

Map

Map 820, in one implementation of IVI, is an image comprising areas on which users can click to quickly move to an image node 200 within IVI window 830. Map 820 is used (see IVI window GUI Component description) to describe externally initiated interaction with external applications and processes 130.

360° View

360° view is a one-location interactive scene that allows users to view a particular static location. Users are expected to rotate their view of the scene by 360° in right or left direction. 360° view is not labeled by a reference numeral herein because 360° view is a general concept used to describe (1) a possible visual content shown through IVI display 840 or (2) an external application or process 130.

IVI is not limited to using the above-specified GUI components. Any other components, or a method of presenting visual content or GUI components, may be used in other implementations of IVI.

### SECOND EMBODIMENT

### Non-Visual Content Interface

The second embodiment of IVI comprises enabling image object links 210 to point to and execute applications or processes outputting non-visual content. The second IVI's embodiment addresses any situation where (1) applications interact with each other in a multi-dimensional linked setting (a situation where no output is shown to the user) and (2) users interact with linked applications that output non-visual content. Any set of applications in need of a multidimensional linked data structure may use the second embodiment of IVI as the underlying data structure.

Functioning of the second IVI embodiment does not differ significantly from the IVI's first embodiment in which IVI shows visual content. The same underlying data structure dynamics apply to the second IVI's embodiment except that showing visual content is, in most instances, not present. All other underlying internal processes found in the first IVI embodiment are substantially the same in the second IVI embodiment.

The reason for, in most instances, not presenting visually non-visual content is that non-visual content often does not have an understandable or meaningful graphical representation to a human user. For example, there is no graphical representation of sound, which IVI may execute as an external application or process in one implementation of the IVI. In general, any embodiment of IVI allows users, or applications or processes to execute applications or processes regardless of whether the executing application or process outputs visual content. In the case that the executing application or process outputs visual content, this visual content may be shown through GUI Component 840. Otherwise, the output is either not shown or the closest graphical representation of the outputted non-visual content is shown.

### OTHER EMBODIMENTS

Other embodiments of IVI relate to improving seamless motion of visual content when a user moves from one image node to another. One reason for this is to allow users to experience a video-like seamless movement through any/all sites, terrains or objects onto or within which IVI is mapped. The way to enhance the fluidity of visual content within IVI is to use a large number of image nodes mapped onto or within a site, terrain or object. This may require recording of a large amount of visual content (e.g., images, but can use other visual content such as video, 360° views, and others). For example, in the case that visual content used within IVI is images, one method of recording synchronized and lined-up images is recording video lines (video recorded in a straight line) that intersect each other in a multi-dimensional matrix (other data structures may be used). Once the video lines are recorded, images for the image nodes are obtained by capturing video frames (video is comprised of changing frames) in a predefined pattern (e.g. capture every fifth frame).

Architecture

IVI may reside and execute on any computing or communication device that is either connected to or disconnected from other computing or communication devices. A computing or communication device may execute IVI on another computing or communication device over a network of any type.

IVI is not limited to use with the hardware/software configuration shown in the figures; it may find applicability in any computing or processing environment. IVI may be implemented in hardware (e.g., an ASIC {Application-Specific Integrated Circuit} and/or an FPGA {Field Programmable Gate Array}), software, or a combination of hardware and software.

IVI may be implemented using one or more computer programs executing on programmable computers connected to or disconnected from a network, that each includes a processor, and a storage medium (e.g., a remote storage server) readable by the processor (including volatile and non-volatile memory and/or storage elements).

Each such program may be implemented in a high level procedural or object-oriented programming language to communicate with a computer system. Also, the programs can be implemented in assembly or machine language. The language may be a compiled or an interpreted language.

Each computer program may be stored on a storage medium or device (e.g., CD-ROM, hard disk, or magnetic diskette) that is readable by a general or special purpose programmable machine for configuring and operating the computer when the storage medium or device is read by the computer to execute IVI.

IVI may also be implemented as a machine-readable storage medium, configured with a computer program, where, upon execution, instructions in the computer program cause the machine to perform the functions described herein.

Other embodiments not described herein are also within the scope of the following claims.

What is claimed is:

1. A method comprising:
defining a structure of nodes, wherein a node comprises a data structure containing a link to content;
selecting the link; and
generating an output that is based on the content.

2. The method of claim 1, wherein the content comprises an object, and generating the output comprises executing code associated with the object.

3. The method of claim 1, wherein the content comprises visual content.

4. The method of claim 1, wherein the visual content comprises one or more of digital images, video, and an interactive process.

5. The method of claim 4, wherein the interactive process is implemented via a graphical user interface.

6. The method of claim 1, wherein the content comprises another node of the structure of nodes.

7. The method of claim 1, wherein the link comprises one of plural links to different content accessible via the node, and selecting the link comprise selecting among the plural links.

8. The method of claim 1, wherein the structure of nodes comprises one or more of the nodes positioned at locations that correspond to content.

9. The method of claim 1, wherein the content comprises non-visual content.

10. The method of claim 1, further comprising:
generating a user interface to interact with the structure of nodes and to present the output.

11. The method of claim 10, wherein the content comprises one of external content and internal content, the internal content being located inside the node and the external content being located outside the node.

12. A machine-readable medium that stores executable instructions, the executable instructions causing a machine to:
define a structure of nodes, wherein a node comprises a data structure containing a link to content;
select the link; and
generate an output that is based on the content.

13. The machine-readable medium of claim 12, wherein the content comprises an object, and generating the output comprises executing code associated with the object.

14. The machine-readable medium of claim 12, wherein the content comprises visual content.

15. The machine-readable medium of claim 12, wherein the visual content comprises one or more of digital images, video, and an interactive process.

16. The machine-readable medium of claim 15, wherein the interactive process is implemented via a graphical user interface.

17. The machine-readable medium of claim 12, wherein the content comprises another node of the structure of nodes.

18. The machine-readable medium of claim 12, wherein the link comprises one of plural links to different content accessible via the node, and selecting the link comprises selecting among the plural links.

19. The machine-readable medium of claim 12, wherein the structure of nodes comprises the nodes positioned at locations that correspond to content.

20. The machine-readable medium of claim 12, wherein the content comprises non-visual content.
